(19) United States
(12) Patent Application Publication
(10) Pub. No.: US 2026/0120290 A1
(43) Pub. Date: Apr. 30, 2026

(54) METHOD AND SERVER FOR TRAINING OBJECT DETECTION MODEL ADAPTIVE TO CAMERA INSTALLATION ENVIRONMENT

(71) Applicant: Suprema Inc., Seongnam-si (KR)

(72) Inventors: Heungjun KIM, Seongnam-si (KR); Bongseop SONG, Seongnam-si (KR); Hyeonchang LEE, Seongnam-si (KR)

(21) Appl. No.: 18/954,252

(22) Filed: Nov. 20, 2024

(30) Foreign Application Priority Data
Oct. 31, 2024 (KR) 10-2024-0152807

(51) Int. Cl. G06T 7/13; G06T 7/246; G06T 7/73; G06V 10/762; G06V 10/774; G06V 20/52

(52) U.S. Cl. CPC G06T 7/13; G06T 7/251; G06T 7/74; G06V 10/762; G06V 10/774; G06T 2207/20081; G06T 2207/30244; G06V 20/52

(57) ABSTRACT

An embodiment relates to a method for training an object detection model adaptive to an installation environment of a camera, the method comprising: acquiring first edge camera information including first viewpoint information corresponding to an installation environment of a first edge camera and first pose information for an object captured by the first edge camera; determining an entire learning dataset including 6D (six-dimensional) pose information representing a 3D (three-dimensional) position and 3D rotation of an object from an image dataset using a pre-trained artificial intelligence model; selecting at least two first learning datasets corresponding to the first edge camera information among the entire learning dataset; and training the object detection model adaptive to the installation environment of the first edge camera through backpropagation using the selected at least two first learning datasets to minimize a pose loss function determined based on poses grouped for each object.

### CROSS-REFERENCE TO RELATED APPLICATION

This application claims priority to Korean Patent Application No. 10-2024-0152807, filed on Oct. 31, 2024, the entirety of which is incorporated herein by reference for all purposes.

### TECHNICAL FIELD

The present disclosure relates to a method and server for training an object detection model adaptive to the installation environment of a camera.

This work was supported by Korea Internet & Security Agency grant funded by the Korea government (Ministry of Science and ICT) (Project No.: KISASupport-2024-28; R&D project: 2024 AI Security Product and Service Commercialization Support Project; Research Project Title: Commercialization of high-performance embedded modules based on cross-recognition technology between heterogeneous cameras; and Project period: 2024.06.01.˜2024.11.30.)

### BACKGROUND

In edge-based image detection devices (e.g., CCTV, black box, kiosk, etc.), in order to know a viewpoint that is an angle at which a camera views a target object, calibration is required to calculate the internal and external parameters of the camera.

The calibration requires a complex process involving detailed specifications of the camera sensor and lens, calibration images, and approximations of the parameters.

Meanwhile, since the shape and features of the target object to be detected in the image vary greatly depending on the viewpoint of the camera, when a lightweight object detection model that is generally trained is used in an edge-based image detection device with a low-spec NPU or CPU, object detection performance may be greatly degraded.

In this regard, a method of utilizing an object detection model trained based on an image dataset classified according to the viewpoints of the camera in different installation environments in for edge-based image detection devices may be considered. However, since the image dataset includes millions of images captured by various camera models, manually classifying the image dataset based on the viewpoints of the camera in different installation environment has the limitation of requiring a lot of time and cost.

Accordingly, there is a need to develop a method for improving the performance of image detection by constructing a learning dataset that is adaptive to the installation environment of edge-based image detection devices and training an object detection model using the constructed learning dataset.

### SUMMARY

In view of the above, an objective of the present disclosure is to improve object detection performance of an edge camera by automatically selecting a learning dataset suitable for the installation environment of a camera from a large image dataset (or object detection dataset) to train an object detection model.

However, the objectives of the present disclosure are not limited to those mentioned above, and other objectives not mentioned may be clearly understood by a person having ordinary skill in the art to which the present disclosure pertains from the description below.

In accordance with one aspect of the present disclosure, there is provided a method for training an object detection model adaptive to an installation environment of a camera, the method comprising: acquiring first edge camera information including first viewpoint information corresponding to an installation environment of a first edge camera and first pose information for an object captured by the first edge camera; determining an entire learning dataset including 6D (six-dimensional) pose information representing a 3D (three-dimensional) position and 3D rotation of an object from an image dataset using a pre-trained artificial intelligence model; selecting at least two first learning datasets corresponding to the first edge camera information among the entire learning dataset; and training the object detection model adaptive to the installation environment of the first edge camera through backpropagation using the selected at least two first learning datasets to minimize a pose loss function determined based on poses grouped for each object.

Preferably, the acquiring the first edge camera information includes acquiring the first viewpoint information and the first pose information at an initialization time of the first edge camera or at preset intervals using a first artificial intelligence model installed on the first edge camera.

Preferably, the acquiring the first edge camera information includes acquiring the first viewpoint information based on a movement direction and perspective change of the captured object.

Preferably, the determining the entire learning dataset includes: inferring a camera viewpoint and an object pose from an image included in the image dataset using the artificial intelligence model; determining the 6D pose information based on the inferred camera viewpoint and object pose; and determining the entire learning dataset through clustering of images included in the image dataset based on the 6D pose information.

Preferably, the determining the entire learning dataset through clustering of the images includes determining the entire learning dataset including at least one cluster corresponding to the object pose based on optimization for at least one first clustering parameter, and wherein the at least one first clustering parameter comprises at least one of parameters related to a cluster range, the number of clusters, and a proportion of an object corresponding to each cluster in the image dataset.

Preferably, the selecting the at least two first learning datasets includes: determining a sampling ratio for each of at least one cluster included in the entire learning dataset based on the first viewpoint information and the first pose information; and determining the at least two first learning datasets based on adjustment to the at least one first clustering parameter and the sampling ratio.

Preferably, the determining the at least two first learning datasets includes determining the at least two first learning datasets based on adjustment to at least one second clustering parameter, and wherein the at least one second clustering parameter includes at least one of parameters related to an inter-cluster distance, an intra-cluster variance, and a cluster selection weight.

Preferably, the training the object detection model adaptive to the installation environment of the first edge camera includes: augmenting the at least two first learning datasets using a mosaic augmentation technique that maintains object poses; and further training the object detection model based on the augmented at least two first learning datasets.

Preferably, the method further comprises determining an optimal object detection model based on performance evaluation of the object detection model trained using the at least two first learning datasets; and distributing the optimal object detection model to the first edge camera.

In accordance with another aspect of the present disclosure, a sever for training an object detection model adaptive to an installation environment of a camera, the server comprising: a memory in which an object detection model training program is stored; and a processor for loading the object detection model training program from the memory and executing the object detection model training program, wherein the processor is configured to perform: acquiring first edge camera information including first viewpoint information corresponding to an installation environment of a first edge camera and first pose information for an object captured by the first edge camera; determining an entire learning dataset including 6D pose information representing a 3D position and 3D rotation of an object from an image dataset using a pre-trained artificial intelligence model; selecting at least two first learning datasets corresponding to the first edge camera information among the entire learning dataset; and training the object detection model adaptive to the installation environment of the first edge camera through backpropagation using the selected at least two first learning datasets to minimize a pose loss function determined based on poses grouped for each object.

Preferably, the processor acquires the first viewpoint information and the first pose information at an initialization time of the first edge camera or at preset intervals using a first artificial intelligence model installed on the first edge camera.

Preferably, the processor acquires the first viewpoint information based on a movement direction and perspective change of the captured object.

Preferably, the processor infers a camera viewpoint and an object pose from an image included in the image dataset using the artificial intelligence model, determines the 6D pose information based on the inferred camera viewpoint and object pose, and determines the entire learning dataset through clustering of images included in the image dataset based on the 6D pose information.

Preferably, the processor determines the entire learning dataset including at least one cluster corresponding to the object pose based on optimization for at least one first clustering parameter, and wherein the at least one first clustering parameter includes at least one of parameters related to a cluster range, the number of clusters, and a proportion of an object corresponding to each cluster in the image dataset.

Preferably, the processor determines a sampling ratio for each of at least one cluster included in the entire learning dataset based on the first viewpoint information and the first pose information, and determines the at least two first learning datasets based on adjustment to the at least one first clustering parameter and the sampling ratio.

Preferably, the processor determines the at least two first learning datasets based on adjustment to at least one second clustering parameter, and wherein the at least one second clustering parameter includes at least one of parameters related to an inter-cluster distance, an intra-cluster variance, and a cluster selection weight.

Preferably, the processor augments the at least two first learning datasets using a mosaic augmentation technique that maintains object poses, and trains the object detection model based on the augmented at least two first learning datasets.

Preferably, the processor determines an optimal object detection model based on performance evaluation of the object detection model trained using the at least two first learning datasets, and distributes the optimal object detection model to the first edge camera.

In accordance with a still another aspect of the present disclosure, there is provided a non-transitory computer-readable recording medium storing a computer program, wherein the computer program including instructions for, when executed by a processor, causing the processor to perform a method for training an object detection model adaptive to an installation environment of a camera, the method comprising: acquiring first edge camera information including first viewpoint information corresponding to an installation environment of a first edge camera and first pose information for an object captured by the first edge camera; determining an entire learning dataset including 6D pose information representing a 3D position and 3D rotation of an object from an image dataset using a pre-trained artificial intelligence model; selecting at least two first learning datasets corresponding to the first edge camera information among the entire learning dataset; and training the object detection model adaptive to the installation environment of the first edge camera through backpropagation using the selected at least two first learning datasets to minimize a pose loss function determined based on poses grouped for each object.

According to one embodiment of the present disclosure, the object detection performance of the first edge camera can be improved by utilizing the object detection model learned based on learning data adaptively selected for the installation environment of the first edge camera.

Further, according to one embodiment of the present disclosure, since the object detection model is learned using selected learning data, the performance of the lightweight object detection model can be improved within the limited CPU performance (or GPU performance) of the first edge camera.

In addition, according to one embodiment of the present disclosure, learning data can be augmented using a mosaic augmentation technique that maintains an object pose while maintaining the pose distribution of the first learning dataset, which has the effect of not damaging the pose and ratio of the object, unlike conventional mosaic augmentation techniques.

Furthermore, according to one embodiment of the present disclosure, by training the object detection model based on a pose loss function, when performance for a specific pose is low, it is possible to strengthen the training for the specific pose by assigning a greater weight to the prediction error of the specific pose, which improves the performance of the object detection model.

### BRIEF DESCRIPTION OF THE DRAWINGS

FIG. 1 is a block diagram showing a server according to one embodiment of the present disclosure.

FIG. 2 is a block diagram conceptually showing the function of an object detection model training program according to one embodiment of the present disclosure.

FIG. 3 is a flowchart illustrating an object detection model training method according to one embodiment of the present disclosure.

FIG. 4 is an exemplary diagrams illustrating a system that selects a learning dataset adaptive to the installation environment of an edge camera using the server according to one embodiment of the present disclosure and distributes an object detection model trained based on the selected learning dataset to the edge camera device.

### DETAILED DESCRIPTION

The advantages and features of embodiments and methods of accomplishing these will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing the embodiments of the present disclosure, if it is determined that detailed description of related known components or functions unnecessarily obscures the gist of the present disclosure, the detailed description thereof will be omitted. Further, the terminologies to be described below are defined in consideration of functions of the embodiments of the present disclosure and may vary depending on a user's or an operator's intention or practice. Accordingly, the definition thereof may be made on a basis of the content throughout the specification.

Hereinafter, before describing the technical ideas according to an embodiment, the terminology will be reviewed.

First, knowledge refers to the perception or understanding acquired through learning or practice regarding a certain object or principle, but it is not limited thereto. Such knowledge may include not only types acquired through experience in everyday life, but may also knowledge acquired by experts in their field of expertise, such as research and development know-how for products. However, it is not limited thereto.

Such knowledge may be manifested in various forms. For example, knowledge may be manifested through oral communication, websites such as social networking services, or in the form of patents or papers, as well as seminars in which the knowledge provider participates. In addition, knowledge may also be manifested in the form of know-how.

Such knowledge may be used across a variety of fields.

For example, there is something applicable in daily life, such as how to remove a stain from clothes or how to easily remove a lid from a sealed container with less effort.

Alternatively, some knowledge may be applicable for developing or designing products or components of these products. In such development or design, specifications of the product (design specification or performance specification, etc.) may be developed or designed. The outcome may be, but is not limited to, blueprints, etc.

Alternatively, some knowledge may be used to resolve a trouble in products or components. Alternatively, some knowledge may be used to implement a given function in products or components. Of course, the categories of knowledge are not limited thereto.

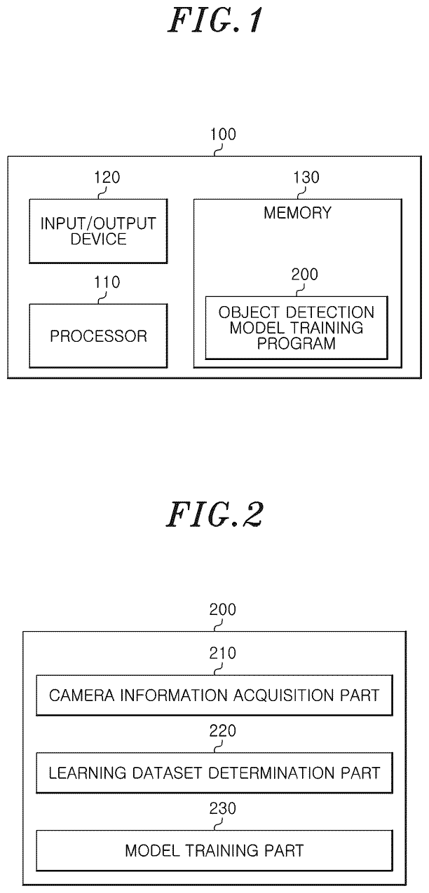

FIG. 1 is a block diagram showing a server 100 according to one embodiment of the present disclosure.

Referring to FIG. 1, the server 100 may include a processor 110, an input/output device 120, and a memory 130.

The processor 110 may control the overall operation of the server 100.

The processor 110 may receive viewpoint information corresponding to the installation environment of an edge camera and pose information about an object captured by the edge camera using the input/output device 120. In addition, the processor 110 may receive image information that does not include a label regarding a crack in a tunnel using the input/output device 120.

In the present disclosure, the edge camera is a device equipped with an artificial intelligence model that autonomously processes data captured by the camera, such as analyzing images captured by the camera and recognizing specific actions, and may include, for example, a CCTV, a black box, a kiosk, etc.

In the present disclosure, viewpoint information corresponding to the installation environment of the edge camera is information about the camera installation angle, and may include information about yaw, pitch, and roll, and position information for a point corresponding to the field of view.

In addition, in the present disclosure, pose information for an object captured by the edge camera is information indicating the posture and position of the object, and may include information indicating a 3D (three-dimensional) position and 3D rotation of the object.

In the present disclosure, the viewpoint information corresponding to the installation environment of the edge camera and the pose information for the object captured by the edge camera are described as being input through the input/output device 120, but the present disclosure is not limited thereto. In other words, according to an embodiment, the server 100 may include a transceiver (not shown), and the server 100 may receive at least one of the viewpoint information corresponding to the installation environment of the edge camera and the pose information for the object captured by the edge camera using the transceiver (not shown), and at least one of the viewpoint information corresponding to the installation environment of the edge camera and the pose information for the object captured by the edge camera may be generated within the server 100.

The processor 110 may acquire first edge camera information including first viewpoint information corresponding to the installation environment of a first edge camera and first pose information for an object captured by the first edge camera, determine an entire learning dataset including 6D (six-dimensional) pose information representing a 3D position and 3D rotation of the object from an image dataset using an artificial intelligence model, select at least two first learning datasets corresponding to the first edge camera information from the entire learning dataset, and train an object detection model adaptive to the installation environment of the first edge camera through backpropagation using the selected at least two first learning datasets to minimize a pose loss function determined based on poses grouped for each object.

The input/output device 120 may include one or more input devices and/or one or more output devices. For example, the input devices may include a microphone, a keyboard, a mouse, a touch screen, etc., and the output devices may include a display, a speaker, etc.

The memory 130 may store an object detection model training program 200 and information required for executing the object detection model training program 200.

In the present specification, the object detection model training program 200 may refer to software including instructions for training an object detection model by receiving first edge camera information including first viewpoint information corresponding to the installation environment of the first edge camera and first pose information for an object captured by the first edge camera.

The processor 110 may load the object detection model training program 200 and information required for executing the object detection model training program 200 from the memory 130 to execute the object detection model training program 200.

The processor 110 may execute the object detection model training program 200 to determine an entire learning dataset including 6D pose information representing a 3D position and 3D rotation of an object from an image dataset, select at least two first learning datasets corresponding to the first edge camera information from the entire learning dataset, and train an object detection model adaptive to the installation environment of the first edge camera through backpropagation using the selected at least two first learning datasets to minimize a pose loss function determined based on poses grouped for each object.

The functions and/or operations of the object detection model training program 200 will be described in detail with reference to FIG. 2.

FIG. 2 is a block diagram conceptually showing the functions of the object detection model training program 200 according to one embodiment of the present disclosure.

Referring to FIG. 2, the object detection model training program 200 may include a camera information acquisition part 210, a learning dataset determination part 220, and a model training part 230.

The camera information acquisition part 210, the learning dataset determination part 220, and the model training part 230 illustrated in FIG. 2 conceptually divide the functions of the object detection model training program 200 in order to easily explain the functions of the object detection model training program 200, but the present disclosure is not limited thereto. According to embodiments, the functions of the camera information acquisition part 210, the learning dataset determination part 220, and the model training part 230 may be combined/separated, and may be implemented as a series of instructions included in one program.

First, the camera information acquisition part 210 may acquire first edge camera information from the first edge camera.

In this case, the first edge camera information is information indicating the position, angle, size, pose distribution (e.g., the posture of an object seen at a specific angle) of an object in the field of view of the camera, and may include first viewpoint information corresponding to the installation environment of the first edge camera and first pose information for an object captured by the first edge camera.

The first edge camera information according to one embodiment of the present disclosure may be expressed by considering the pose distribution, as shown in the following Equation 1.

$$\begin{matrix}( Equation 1 ) & \\ {P}_{edge} = [ {p}_{edge , 1} , {p}_{edge , 2} , {p}_{edge , 3} , ... , {p}_{edge , k} ] & \end{matrix}$$

where, P_{edge,k} represents a frequency in a specific pose cluster.

Specifically, the camera information acquisition part 210 may acquire the first viewpoint information and the first pose information at the initialization time of the first edge camera or at preset intervals by using a first artificial intelligence model installed on the first edge camera.

For example, considering the CPU or GPU performance of the first edge camera, the camera information acquisition part 210 may calculate the viewpoint and infer the pose of the captured object at the initialization time of the first edge camera or at preset intervals through a yolo-6D Pose model installed on the first edge camera.

In addition, the camera information acquisition part 210 may calculate the external parameters of the first edge camera and the viewpoint of the first edge camera from the inferred pose of the object using the solve PnP and RANSAC algorithms.

Meanwhile, the yolo-6D Pose model installed on the first edge camera according to one embodiment of the present disclosure is only an example, and the first artificial intelligence model may be varied in any way that achieves the objectives of the present disclosure.

In addition, the camera information acquisition part 210 may acquire the first viewpoint information based on the movement direction and perspective change of the object being captured by the first edge camera.

For example, the camera information acquisition part 210 may acquire the first viewpoint information using a SFM (structure from motion) algorithm or a SLAM (simultaneous localization and mapping) algorithm.

In addition, the camera information acquisition part 210 may acquire the first viewpoint information set based on the user's operation through a GUI (graphical user interface).

Next, the learning dataset determination part 220 may determine the entire learning dataset including 6D pose information indicating the 3D position and 3D rotation of the object from the image dataset using an artificial intelligence model.

In this case, the image dataset (or object detection dataset) is generally an open dataset that is learned for object detection (or sensing), and does not include information on the viewpoint of the camera.

Specifically, the learning dataset determination part 220 may infer the viewpoint of the camera and the object pose from the images included in the image dataset using the artificial intelligence model.

For example, the learning dataset determination part 220 may input an image dataset into the yolo-6D pose model to infer the viewpoint of each image included in the image dataset and the pose of the object included in each image.

Meanwhile, the yolo-6D Pose model for determining the entire learning dataset according to one embodiment of the present disclosure is only an example, and the artificial intelligence model may be varied in any way that achieves the objectives of the present disclosure.

In addition, the learning dataset determination part 220 may determine 6D pose information based on the inferred camera viewpoint and object pose.

In this case, the 6D pose information may include a pose vector configured based on information about the object's x, y, z coordinates and pitch, yaw, and roll, and the pose vector according to one embodiment of the present disclosure may be expressed as shown in the following Equation 2.

$$\begin{matrix}( Equation 2 ) & \\ {P}_{dataset} = [ {p}_{dataset , 1} , {p}_{dataset , 2} , {p}_{dataset , 3} , ... , {p}_{dataset , N} ] & \end{matrix}$$

where, P_{dataset,N} represents an individual pose vector extracted from the image dataset.

Meanwhile, the learning dataset determination part 220 may perform preprocessing on the 6D pose information.

For example, the learning dataset determination part 220 may perform quantization or normalization to convert the values of pose vectors from real numbers to integers to increase computational efficiency for the learning data.

As another example, the learning dataset determination part 220 may perform quantization or normalization to convert the range of angles for pitch, yaw, and roll included in the pose vector into 200 steps within 360 degrees to increase the computational efficiency for the learning data.

In this case, the quantized angle according to one embodiment of the present disclosure may be expressed as shown in the following Equation 3.

$$\begin{matrix}( Equation 3 ) & \\ Quantized angle = [ \frac{θ}{1.8} ] & \end{matrix}$$

where, θ presents the angle included in the pose vector, and the quantized angle can be converted to an integer.

Meanwhile, the values of the quantized pose vector may be referenced to a lookup table, and may be mapped to values for the actual coordinates and angles through the lookup table.

In addition, the learning dataset determination part 220 may determine the entire learning dataset through clustering of images included in the image dataset based on the 6D pose information.

For example, the learning dataset determination part 220 may determine the entire learning dataset using a k-means clustering algorithm.

Specifically, the learning dataset determination part 220 may determine the entire learning dataset including at least one cluster corresponding to the object pose based on optimization of at least one first clustering parameter.

In this case, the at least one first clustering parameter may include at least one of parameters related to a cluster range, the number of clusters, and the proportion of objects corresponding to each cluster in the image dataset.

The parameter related to the cluster range, according to one embodiment, is a parameter (hereinafter, referred to as ‘A’) that determines how diversely object poses can be distributed around the center of the cluster. For example, the smaller the value of the parameter, the more similar poses may be included in the cluster, and the larger the value of the parameter, the more diverse poses may be included in the cluster.

Further, the parameter related to the number of clusters, according to one embodiment, may refer to a parameter (hereinafter, referred to as ‘N’) that determines the number of representative poses to be used for training.

In addition, the parameter related to the ratio of objects corresponding to each cluster, according to one embodiment, may refer to a parameter (hereinafter, referred to as ‘R’) that determines whether the object detection model to be trained is focused on a specific pose or whether the training is balanced.

Meanwhile, at least one first clustering parameter may be automatically adjusted for optimization.

For example, when the object pose distribution of a cluster is out of a certain range, ‘A’ can be automatically adjusted to change the size of the cluster.

As another example, when a specific pose is lacking or excessive during the training of an object detection model, ‘R’ can be automatically adjusted to form an optimal distribution of object poses for training the object detection model.

In this way, by inferring 6D pose information from an image dataset, which is an open dataset, and performing clustering based on this information, it is possible to generate an entire learning dataset including clusters that are automatically classified by considering the camera viewpoint and object poses.

Next, the learning dataset determination part 220 may select at least two first learning datasets corresponding to the first edge camera information from the entire learning dataset.

Specifically, the learning dataset determination part 220 may determine a sampling ratio for each of at least one cluster included in the entire learning dataset based on the first viewpoint information and the first pose information.

In this case, the sampling ratio according to one embodiment of the present disclosure may be expressed as shown in the following Equation 4.

$$\begin{matrix}( Equation 4 ) & \\ {S}_{k} = min ( 1 , \frac{{p}_{edge , k}}{{p}_{dataset , k}} ) & \end{matrix}$$

where, Sₖ represents the sampling ratio for each cluster Ck included in the entire learning dataset.

In addition, the learning dataset determination part 220 may determine at least two first learning datasets based on the adjustment to at least one first clustering parameter and the sampling ratio.

For example, the learning dataset determination part 220 may determine at least two first learning datasets by adjusting ‘N’ in consideration of the number of target representative poses and extracting data included in each cluster according to the sampling ratio.

Meanwhile, the learning dataset determination part 220 may determine at least two first learning datasets based on the adjustment to at least one second clustering parameter.

In this case, at least one second clustering parameter may include at least one of parameters related to an inter-cluster distance, an intra-cluster variance, and a cluster selection weight.

The parameter related to the inter-cluster distance, according to one embodiment, is a parameter representing the distance between the centers of clusters, which may be adjusted to make the pose distribution similar to that included in the first edge camera information, and the parameter may be expressed as shown in the following Equation 5.

$$\begin{matrix}( Equation 5 ) & \\ {d}_{inter} = \frac{1}{{n}_{clusters}} {\sum }_{i , j = 1 , i \neq j}^{{n}_{clusters}} ‖ {C}_{i} - {C}_{j} ‖ & \end{matrix}$$

where, Cᵢ and Cⱼ represent the centers of the respective clusters.

In addition, the parameter related to the intra-cluster variance, according to one embodiment, is a parameter that adjusts the cluster range to maintain the representativeness of the poses included in each cluster, and the parameter may be expressed as shown in the following Equation 6.

$$\begin{matrix}( Equation 6 ) & \\ {σ}_{intra} = \frac{1}{{n}_{clusters}} {\sum }_{i = 1}^{{n}_{clusters}} \frac{1}{\vert {S}_{i} \vert} {\sum }_{x ∈ {S}_{i}} {‖ x - {C}_{i} ‖}^{2} & \end{matrix}$$

where, Sᵢ represents a sample set of cluster i.

In addition, the parameter related to the cluster selection weight, according to one embodiment, is a parameter that enables sampling more data according to the importance of a cluster, which may be adjusted to make the pose distribution similar to that included in the first edge camera information, and the parameter may be expressed as shown in the following Equation 7.

$$\begin{matrix}( Equation 7 ) & \\ {w}_{cluster} ( i ) = \frac{{n}_{i}}{N} \cdot \frac{{p}_{i}}{{\sum }_{j = 1}^{k} {p}_{j}} & \end{matrix}$$

where, nᵢ represents the number of data in cluster i, and pᵢ represents the probability of the pose distribution for cluster i within the pose distribution included in the first edge camera information.

In this way, by adjusting the first clustering parameter or the second clustering parameter to make the pose distribution similar to that included in the first edge camera information, it is possible to determine the first learning dataset for training an object detection model adaptive to the installation environment of the first edge camera.

Next, the model training part 230 may train an object detection model adaptive to the installation environment of the first edge camera through backpropagation using at least two selected first learning datasets to minimize a pose loss function determined based on poses grouped for each object.

The at least two first learning datasets selected according to one embodiment of the present disclosure include pose distributions grouped for each object. In this case, the model training part 230 may update the weights of the object detection model through backpropagation to minimize the pose loss function for object poses with low performance.

The pose loss function according to one embodiment may be expressed as the following Equation 8.

$$\begin{matrix}( Equation 8 ) & \\ {L}_{PAL} = {L}_{cls} + {L}_{box} + α \cdot {L}_{pose} & \end{matrix}$$

where, L_{PAL} represents pose loss function, L_{cls} represents class loss, L_{box} represents bounding box loss, Lₚₒₛₑ represents pose-based loss, and a represents a hyperparameter that means a weight for the pose-based loss.

In this way, by training the object detection model based on the pose loss function, when performance for a specific pose is low, a greater weight can be given to the prediction error of the specific pose to strengthen training for the specific pose, which improves the performance of the object detection model.

Meanwhile, the model training part 230 may augment at least two first learning datasets using a mosaic augmentation technique that maintains object poses.

In this case, the mosaic augmentation technique that maintains object poses according to one embodiment may mean a technique that performs cropping on individual images included in the learning dataset by considering pose distribution of the individual images, and maintains consistency of poses even when combining them into a mosaic image.

The mosaic augmentation technique based on target pose distribution according to one embodiment of the present disclosure may be expressed as the following Equation 9.

$$\begin{matrix}( Equation 9 ) & \\ {P}_{goal} ( x , y , θ ) & ( 1 )\end{matrix}$$

$${P}_{i} ( x , y , θ ) \qquad ( 2 )$$

$${P}_{crop} ( x , y , θ ) = {P}_{i} ( {x}_{crop} , {y}_{crop} , θ ) \qquad ( 3 )$$

$$arg {min}_{{x}_{crop} , {y}_{crop} , θ} \vert {P}_{goal} ( x , y , θ ) - {P}_{i} ( {x}_{crop} , {y}_{crop} , θ ) \vert \qquad ( 4 )$$

$${P}_{mosaic} ( x , y , θ ) = {\sum }_{i} {α}_{i} {β}_{i} {P}_{i} ( {x}_{crop} , {y}_{crop} , θ ) \qquad ( 5 )$$

$$arg {min}_{{α}_{i} , {β}_{i} , {x}_{crop} , {y}_{crop} , θ} \vert {P}_{goal} ( x , y , θ ) - {P}_{mosaic} ( x , y , θ ) \vert \qquad ( 6 )$$

(1) in Equation 9 represents the definition of the target pose distribution, where x, y denotes the positions within the image, and 0 represents the angle of the pose.

Next, referring to (2) in Equation 9, Pᵢ (x, y, θ) represents the pose distribution extracted from each image included in the first learning dataset.

Next, referring to (3) and (4) in Equation 9, it indicates that the crop center is selected so that the cropped area in the image can maintain the pose distribution as much as possible, and it is set to minimize the difference from the target pose distribution. Here, x_{crop}, y_{crop} represent the center coordinates of the area to be cropped.

Next, referring to (5) in Equation 9, the pose distribution of the combined mosaic image represents the sum of the pose distributions of the cropped images, where P_{mosaic} (x, y, θ) represents the pose distribution of the combined mosaic image, and αᵢβᵢ represents the proportion of the cropped area in each image relative to the entire mosaic image.

Next, referring to (6) in Equation 9, it indicates that the pose distribution of the combined mosaic image is made to minimize the difference between the pose distribution of the combined mosaic image and the target pose distributions based on the adjustments to the crop position and size.

In other words, the model training part 230 can augment learning data using the mosaic augmentation technique while maintaining the pose distribution of the first learning dataset, which has the effect of not damaging the poses and proportions of the objects unlike conventional mosaic augmentation techniques.

Meanwhile, the model training part 230 may determine an optimal object detection model based on performance evaluation of the object detection models trained using at least two first learning datasets.

For example, the model training part 230 may evaluate the class-wise accuracy of the predicted object and the pose-wise accuracy of the predicted object for each object detection model trained using at least two first learning datasets.

Further, the model training part 230 may determine the optimal object detection model by referring to the class-wise accuracy of the predicted object and the pose-wise accuracy of the predicted object.

In addition, the model training part 230 may distribute the optimal object detection model to the first edge camera.

Through this process, by utilizing an object detection model trained based on learning data adaptively selected for the installation environment of the first edge camera, the object detection performance in the first edge camera can be improved.

In addition, as the object detection model is trained using the selected learning data, the performance of the lightweight object detection model can be improved within the limited CPU performance (or GPU performance) of the first edge camera.

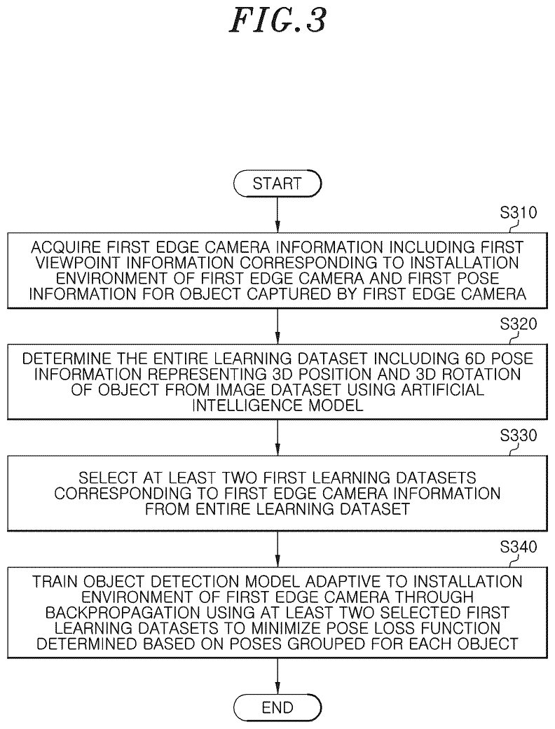

FIG. 3 is a flowchart illustrating an object detection model training method according to one embodiment of the present disclosure.

Referring to FIG. 3, the camera information acquisition part 210 may acquire first edge camera information including first viewpoint information corresponding to the installation environment of the first edge camera and first pose information for an object captured by the first edge camera (S310).

Next, the learning dataset determination part 220 may determine the entire learning dataset including 6D pose information representing the 3D position and 3D rotation of the object from the image dataset using an artificial intelligence model (S320).

Then, the learning dataset determination part 220 may select at least two first learning datasets corresponding to the first edge camera information from the entire learning dataset (S330).

Next, the model training part 230 may train an object detection model adaptive to the installation environment of the first edge camera through backpropagation using at least two selected first learning datasets to minimize a pose loss function determined based on poses grouped for each object (S340).

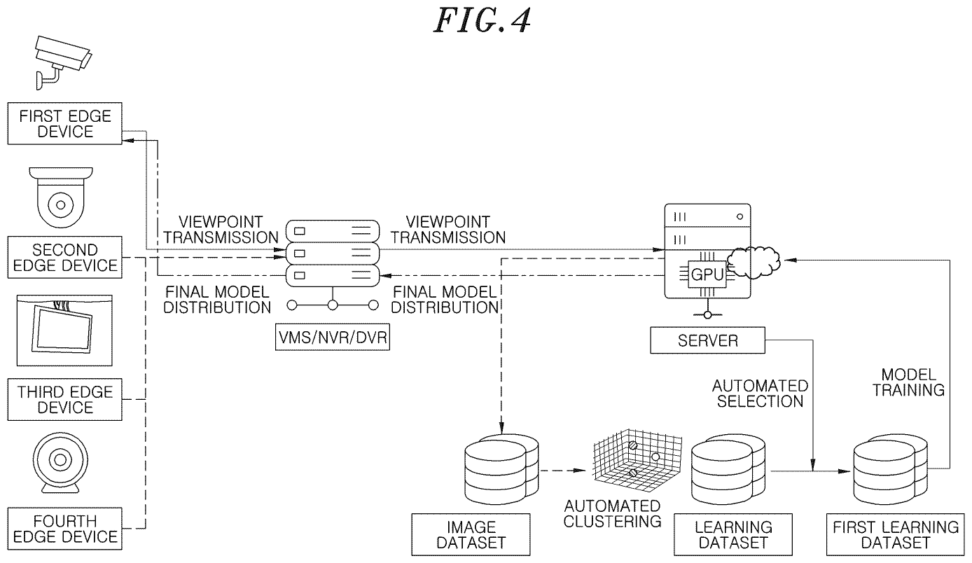

FIG. 4 is an exemplary diagram illustrating a system that selects a learning dataset adaptive to the installation environment of an edge camera using the server 100 according to one embodiment of the present disclosure, and distributes an object detection model trained based on the selected learning dataset to the edge camera device.

Referring to FIG. 4, the server 100 may receive viewpoint information and pose information from a first edge device to a fourth edge device.

In this case, the server 100 may receive the viewpoint information and pose information from the first edge device to the fourth edge device using a video management system (VMS), a network video recorder (NVR), and a digital video recorder (DVR).

Hereinafter, a case in which the server 100 receives first viewpoint information and first pose information from the first edge device will be described.

First, the server 100 may infer the camera viewpoint and object pose from images included in an image dataset using an artificial intelligence model (e.g., a yolo-6D pose model), and determine 6D pose information based on the inferred camera viewpoint and the object pose.

Next, the server 100 may determine the entire learning dataset through clustering of the images included in the image dataset based on the 6D pose information.

In this case, the server 100 may automatically determine a learning dataset including at least one cluster corresponding to the object pose based on a clustering algorithm.

Then, the server 100 may determine a sampling ratio for each of at least one cluster included in the learning dataset based on the first viewpoint information and the first pose information, and may automatically select at least two first learning datasets based on adjustments to at least one clustering parameter and the sampling ratio.

Next, the server 100 may train an object detection model adaptive to the installation environment of the first edge camera through backpropagation using the selected at least two first learning datasets to minimize a pose loss function determined based on poses grouped for each object.

In this case, the server 100 may determine the optimal object detection model as the final model based on a performance evaluation of the object detection model trained using the at least two first learning datasets.

Next, the server 100 may distribute the final model to the first edge device, and update the artificial intelligence model embedded in the first edge device with the final model.

Through this process, the first edge device can perform image detection using the object detection model that has been adaptively trained for its installation environment.

Combinations of each block of the block diagrams and each step of the flowchart attached to the present disclosure may be performed by computer program instructions. Since these computer program instructions can be installed in an encoding processor of a general-purpose computer, a special-purpose computer, or other programmable data processing equipment, the instructions executed through the encoding processor of the computer or other programmable data processing equipment generate means for executing functions described in each block of the block diagrams or each step of the flowchart. These computer program instructions may also be stored in a computer-usable or computer-readable memory that can be directed to computers or other programmable data processing equipment to implement functions in a particular way, and thus the instructions stored in the computer-usable or computer-readable memory can also produce manufactured items containing instruction means for executing the functions described in each block of the block diagram or each step of the flowchart. Since the computer program instructions can also be installed in a computer or other programmable data processing equipment, a series of operational steps may be performed on the computer or other programmable data processing equipment to create a process that is executed by the computer, thereby providing steps for executing the functions described in each block of the block diagrams and each step of the flowchart through the instructions.

Additionally, each block or each step may represent a module, a segment, or some code that includes one or more executable instructions for executing specified logical function(s). Additionally, it should be noted that, in some alternative embodiments, the functions mentioned in blocks or steps are executed out of order. For example, two blocks or steps shown in succession may be performed substantially simultaneously, or the blocks or steps may sometimes be performed in reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for training an object detection model adaptive to an installation environment of a camera, the method comprising:
acquiring first edge camera information including first viewpoint information corresponding to an installation environment of a first edge camera and first pose information for an object captured by the first edge camera;
determining an entire learning dataset including 6D (six-dimensional) pose information representing a 3D (three-dimensional) position and 3D rotation of an object from an image dataset using a pre-trained artificial intelligence model;
selecting at least two first learning datasets corresponding to the first edge camera information among the entire learning dataset; and
training the object detection model adaptive to the installation environment of the first edge camera through backpropagation using the selected at least two first learning datasets to minimize a pose loss function determined based on poses grouped for each object.

2. The method of claim 1, wherein the acquiring the first edge camera information includes acquiring the first viewpoint information and the first pose information at an initialization time of the first edge camera or at preset intervals using a first artificial intelligence model installed on the first edge camera.

3. The method of claim 1, wherein the acquiring the first edge camera information includes acquiring the first viewpoint information based on a movement direction and perspective change of the captured object.

4. The method of claim 1, wherein the determining the entire learning dataset includes:
inferring a camera viewpoint and an object pose from an image included in the image dataset using the artificial intelligence model;
determining the 6D pose information based on the inferred camera viewpoint and object pose; and
determining the entire learning dataset through clustering of images included in the image dataset based on the 6D pose information.

5. The method of claim 4, wherein the determining the entire learning dataset through clustering of the images includes determining the entire learning dataset including at least one cluster corresponding to the object pose based on optimization for at least one first clustering parameter, and
wherein the at least one first clustering parameter comprises at least one of parameters related to a cluster range, the number of clusters, and a proportion of an object corresponding to each cluster in the image dataset.

6. The method of claim 5, wherein the selecting the at least two first learning datasets includes:
determining a sampling ratio for each of at least one cluster included in the entire learning dataset based on the first viewpoint information and the first pose information; and
determining the at least two first learning datasets based on adjustment to the at least one first clustering parameter and the sampling ratio.

7. The method of claim 6, wherein the determining the at least two first learning datasets includes determining the at least two first learning datasets based on adjustment to at least one second clustering parameter, and
wherein the at least one second clustering parameter includes at least one of parameters related to an inter-cluster distance, an intra-cluster variance, and a cluster selection weight.

8. The method of claim 1, wherein the training the object detection model adaptive to the installation environment of the first edge camera includes:
augmenting the at least two first learning datasets using a mosaic augmentation technique that maintains object poses; and
further training the object detection model based on the augmented at least two first learning datasets.

9. The method of claim 1, further comprising:
determining an optimal object detection model based on performance evaluation of the object detection model trained using the at least two first learning datasets; and
distributing the optimal object detection model to the first edge camera.

10. A sever for training an object detection model adaptive to an installation environment of a camera, the server comprising:
a memory in which an object detection model training program is stored; and
a processor for loading the object detection model training program from the memory and executing the object detection model training program,
wherein the processor is configured to perform:
acquiring first edge camera information including first viewpoint information corresponding to an installation environment of a first edge camera and first pose information for an object captured by the first edge camera;
determining an entire learning dataset including 6D pose information representing a 3D position and 3D rotation of an object from an image dataset using a pre-trained artificial intelligence model;
selecting at least two first learning datasets corresponding to the first edge camera information among the entire learning dataset; and
training the object detection model adaptive to the installation environment of the first edge camera through backpropagation using the selected at least two first learning datasets to minimize a pose loss function determined based on poses grouped for each object.

11. The server of claim 10, wherein the processor acquires the first viewpoint information and the first pose information at an initialization time of the first edge camera or at preset intervals using a first artificial intelligence model installed on the first edge camera.

12. The server of claim 10, wherein the processor acquires the first viewpoint information based on a movement direction and perspective change of the captured object.

13. The server of claim 10, wherein the processor infers a camera viewpoint and an object pose from an image included in the image dataset using the artificial intelligence model, determines the 6D pose information based on the inferred camera viewpoint and object pose, and determines the entire learning dataset through clustering of images included in the image dataset based on the 6D pose information.

14. The server of claim 13, wherein the processor determines the entire learning dataset including at least one cluster corresponding to the object pose based on optimization for at least one first clustering parameter, and
wherein the at least one first clustering parameter includes at least one of parameters related to a cluster range, the number of clusters, and a proportion of an object corresponding to each cluster in the image dataset.

15. The server of claim 14, wherein the processor determines a sampling ratio for each of at least one cluster included in the entire learning dataset based on the first viewpoint information and the first pose information, and determines the at least two first learning datasets based on adjustment to the at least one first clustering parameter and the sampling ratio.

16. The server of claim 15, wherein the processor determines the at least two first learning datasets based on adjustment to at least one second clustering parameter, and
wherein the at least one second clustering parameter includes at least one of parameters related to an inter-cluster distance, an intra-cluster variance, and a cluster selection weight.

17. The server of claim 10, wherein the processor augments the at least two first learning datasets using a mosaic augmentation technique that maintains object poses, and trains the object detection model based on the augmented at least two first learning datasets.

18. The server of claim 10, wherein the processor determines an optimal object detection model based on performance evaluation of the object detection model trained using the at least two first learning datasets, and distributes the optimal object detection model to the first edge camera.

19. A non-transitory computer-readable recording medium storing a computer program, wherein the computer program including instructions for, when executed by a processor, causing the processor to perform a method for training an object detection model adaptive to an installation environment of a camera, the method comprising:
acquiring first edge camera information including first viewpoint information corresponding to an installation environment of a first edge camera and first pose information for an object captured by the first edge camera;
determining an entire learning dataset including 6D pose information representing a 3D position and 3D rotation of an object from an image dataset using a pre-trained artificial intelligence model;
selecting at least two first learning datasets corresponding to the first edge camera information among the entire learning dataset; and
training the object detection model adaptive to the installation environment of the first edge camera through backpropagation using the selected at least two first learning datasets to minimize a pose loss function determined based on poses grouped for each object.
